(19) United States
(12) Patent Application Publication
(10) Pub. No.: US 2019/0116757 A1
(43) Pub. Date: Apr. 25, 2019

(54) NECK GARMENT FOR MAMMALS

(71) Applicants: Deborah Marcus, (US); Elina Fishman, (US)

(72) Inventor: Deborah Marcus, Bergenfield, NJ (US)

(21) Appl. No.: 15/793,725

(22) Filed: Oct. 25, 2017

(51) Int. Cl. A01K 13/00

(52) U.S. Cl. CPC A01K 13/006; A41D 23/00

(57) ABSTRACT

Disclosed is a neck garment for mammals. The neck garment comprises a neck portion, a belt, and a head portion. The neck portion is made by crocheting a back loop stitch in order to surround neck of the mammal. The belt comprises a plurality of strings made by crocheting a single stitch. In one aspect, the belt is passed through the neck portion in order to control movement of the neck portion. The head portion is made by crocheting at least one of the single stitch and a double stitch. In one aspect, the head portion comprises a first end and a second end. The first end is interconnected with the neck portion. The second end outwardly extends till head of the mammal in a manner such that the second end surrounds face of the mammal.

### CROSS REFERENCE TO RELATED APPLICATIONS

This patent application does not claim priority from any application.

### TECHNICAL FIELD

The present subject matter described herein, in general, relates to a neck garment for a mammal. More specifically, the neck garment made by crocheting one of a single stitch, a single knit stitch, a double crochet stitch, a double knit crochet stitch, and a back loop stitch from a yarn.

### BACKGROUND

In general, animals tend to lick and/or bite their wounded body part(s) with their tongue and teeth. However, in most cases, licking and/or biting may aggravate the wound and hence makes it restive for the animals. In order to restrict the animals from licking and/or biting their own body parts, considerable efforts have been made to design a protective cone for the animals. It has been observed that the conventional protective cone is made of rigid materials including hard plastic that keeps the protective cone in an upright position. Though the conventional protective cone restricts the animals from licking or biting, it causes severe discomfort and/or wound to the animal.

### SUMMARY

It may be understood that the terminology used in the description is for the purpose of describing the particular versions or embodiments only, and is not intended to limit the scope of the present application. This summary is provided to introduce concepts related to a neck garment for a mammal and the concepts are further described below in the detailed description. It must be noted that the neck garment hereinafter may also be interchangeably referred as at least one of a head garment, a head device and a neck device. This summary is not intended to identify essential features of the claimed subject matter nor is it intended for use in determining or limiting the scope of the claimed subject matter.

In an implementation, a neck garment for a mammal is disclosed. The neck garment may comprise a neck portion, a belt, and a head portion. The neck portion is made by crocheting a back loop stitch. In one aspect, the neck portion surrounds neck of the mammal. The belt may comprise a plurality of strings made by crocheting a single stitch. In one aspect, the belt passes through the neck portion in order to control movement of the neck portion. In an example, mammal's collar may be used in lieu of the belt. The head portion may be made by crocheting at least one of the single stitch, a single crochet stitch, a double crochet stitch, and a double knit crochet stitch. In one aspect, the head portion may comprise a first end and a second end. The first end is interconnected with the neck portion by crocheting at least one of the single stitch, the single crochet stitch, the double crochet stitch, and the double knit crochet stitch. The second end, on the other hand, may outwardly extend till head of the mammal in a manner such that the second end surrounds face of the mammal.

### BRIEF DESCRIPTION OF THE DRAWINGS

The foregoing detailed description of embodiments is better understood when read in conjunction with the appended drawings. For the purpose of illustrating the disclosure, example constructions of the disclosure are shown in the present document; however, the disclosure is not limited to the specific device disclosed in the document and the drawings.

The detailed description is given with reference to the accompanying figures. In the figures, the left-most digit(s) of a reference number identifies the figure in which the reference number first appears. The same numbers are used throughout the drawings to refer like features and components.

FIG. 1 illustrates a side view of a neck garment for a mammal, in accordance with an embodiment of the present subject matter.

FIG. 2 illustrates the neck garment facilitating calming purpose, in accordance with an embodiment of the present subject matter.

FIG. 3 illustrates the neck garment facilitating medical purpose, in accordance with an embodiment of the present subject matter.

### DETAILED DESCRIPTION

Some embodiments of this disclosure, illustrating all its features, will now be discussed in detail. It must be noted that as used herein and in the appended claims, the singular forms “a,” “an,” and “the” include plural references unless the context clearly dictates otherwise. Although any devices similar or equivalent to those described herein can be used in the practice of embodiments of the present disclosure, the exemplary, device is now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

The present invention discloses a neck garment for a mammal. In one implementation, the neck garment may restrict the mammal from licking or biting a body part of the mammal. In another implementation, the neck garment may allow the mammal to protrude out from the head portion. The neck garment is made from a yarn, consisting of a cotton shell with nylon filling, for providing cushioning to the mammal. In an embodiment, the neck garment is made by crocheting the yarn in a manner such that the neck garment appears to be a soft and breathable garment. The neck garment may comprise a neck portion, a belt and a head portion. The neck garment is made by crocheting a combination of a single stitch, a single crochet stitch, a double crochet stitch, a double knit crochet stitch and a back loop stitch. It must be understood that the neck portion is tied to neck of the mammal. The belt is passed through the neck portion to provide security to the neck garment. In an example, a collar worn by the mammal may be passed through the neck portion to provide security to the neck garment. The head portion may extend from the neck portion till the head of the mammal in a manner such that the head portion surrounds face of the mammal. In an implementation, the neck garment may have at least one of a conical shape, a circular shape and a cylindrical shape.

While aspects of described neck garment (hereinafter may also be referred as a ‘head garment’, a ‘head device’ and a ‘neck device’) for a mammal may be implemented in any number of different combinations, the embodiments are described in the context of the following exemplary device.

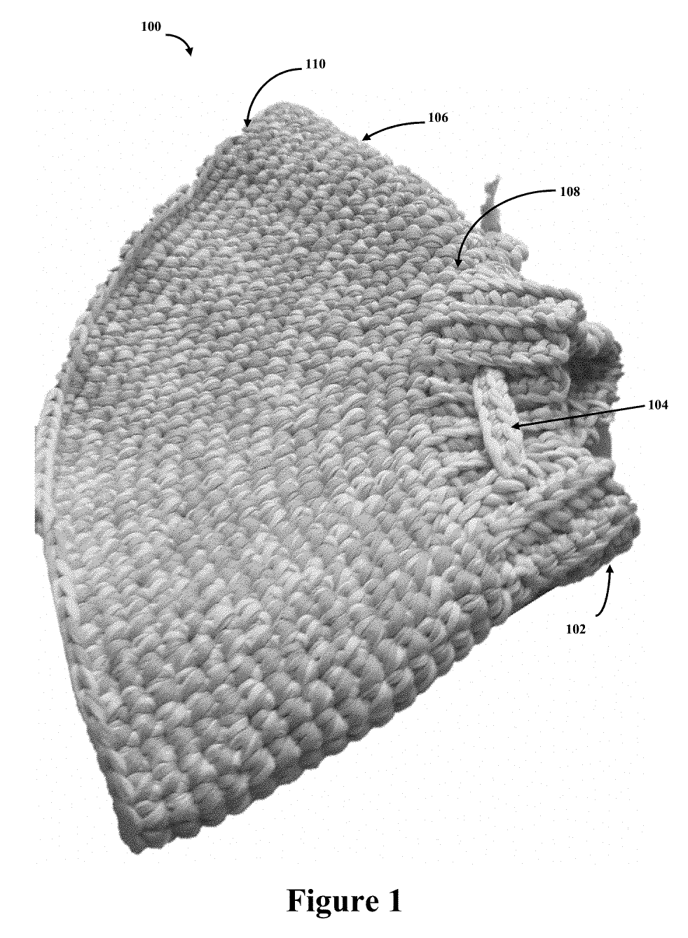

Referring now to FIG. 1, a side view of a neck garment 100 for a mammal is disclosed. In one aspect, the neck garment 100 may comprise a neck portion 102, a belt 104, and a head portion 106. In another aspect, the neck garment 100 may only comprise the neck portion 102. The neck portion 102 is made by crocheting a back loop single stitch. In an alternate embodiment, the neck portion 102 may also be made by crocheting a back loop double stitch. The neck portion 102 is designed in a manner such that the neck portion 102 surrounds neck of the mammal. It may be noted that the neck portion 102 made by crocheting, the back loop stitch, provides flexibility and cushioning to the neck of the mammal. In an example of the invention, the neck portion 102 may be designed in a circular shape having parameters including, but not limited to, a width and a circumference. In an exemplary embodiment, the width is ranging between 1.5 inch to 4 inch. The circumference, on the other hand, is ranging between 8 inch to 22 inch.

In one embodiment, the neck portion 102 may comprise a cuff made by crocheting at least one of the back loop single stitch and the back loop double stitch. The cuff may facilitate fastening of the neck garment 100 with at least a belt and a collar woven through the cuff in order to control the movement of the neck garment and securing the neck portion 102 on the mammal.

In an alternate embodiment, the neck portion 102 may comprise a plurality of hoops made by crocheting at least one of a back loop single stitch and a back loop double stich. It may be noted that the plurality of hoops may facilitate retrofitting of the neck portion 102 with a cone. It may be understood that the cone may be made of hard materials including plastic. In one example, the cone may outwardly extend till head of the mammal in a manner such that the cone surrounds face of the mammal thereby allowing the mammal to protrude out from the cone. In another example, the cone may extend beyond the head of the mammal thereby restricting the mammal to lick or bite other body parts of the mammal.

In addition to the neck portion 102, the neck garment 100 may comprise the belt 104. The belt 104, further, may comprise a plurality of strings made by crocheting a single stitch. In one aspect, the belt 104 may comprise two strings made by a single crochet stitch. In one aspect, the belt 104 may be passed through the neck portion 102 in order to control the movement of the neck portion 102. In one aspect, the belt 104 may facilitate loosening and tightening of the neck portion 102.

Further, the neck garment 100 may comprise the head portion 106. The head portion 106 may be made by crocheting at least one of the single stitch a single crochet stitch, a double crochet stitch, and a double knit crochet stitch. The head portion 106 may comprise a first end 108 and a second end 110. The first end 108 is interconnected with the neck portion 102 by crocheting at least one of the single stitch, the single crochet stitch, the double crochet stitch, and the double knit crochet stitch. The second end 110, on the other hand, may outwardly extend till head of the mammal in a manner such that the second end 110 surrounds face of the mammal thereby allowing the mammal to protrude out from the head portion 106. In an exemplary embodiment, second end 110 may extend beyond the head of the mammal thereby restricting the mammal to lick or bite other body parts of the mammal.

It must be noted that crocheting at least one of the single stitch, the single crochet stitch, the double crochet stitch, and the double knit crochet stitch keeps the second end 110 in an upright position. In one example, the second end 110 may have length ranging between 3.75 inch to 14 inch. In another example, the head portion 106 may be designed in a manner such that the head portion 106 may have at least one of a conical shape, a circular shape and a cylindrical shape.

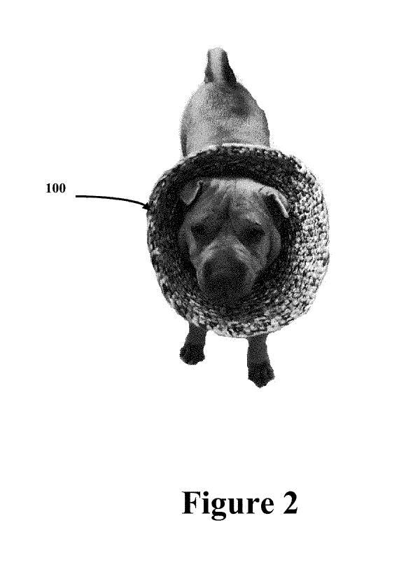

Referring now to FIG. 2, the neck garment 100 facilitating calming purpose is illustrated in accordance with an embodiment of the present subject matter. In order to facilitate the calming purpose, the neck garment 100 extends till the head of the dog in a manner such that the neck garment 100 surrounds face of the dog. As illustrated, the neck garment 100 allows dog to protrude out from the neck garment 100. In an exemplary embodiment, the head portion may have the length ranging between 3.75 inch to 10 inch.

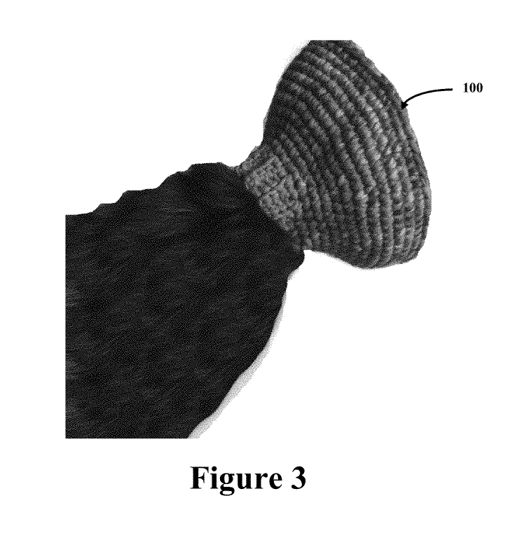

Referring now to FIG. 3, the neck garment 100 facilitating medical purpose is illustrated in accordance with an embodiment of the present subject matter. In order to facilitate the medical purpose, the neck garment 100 extends beyond the head in order to restrict the dog from licking or biting any other body part of the dog. In an exemplary embodiment, the neck garment 100 may have the length ranging between 4.25 inch to 14 inch.

Exemplary embodiments discussed above may provide certain advantages. Though not required to practice aspects of the disclosure, these advantages may include those provided by the following features.

Some embodiments of the disclosed neck garment may protect the mammal from licking or biting an injured body part of the mammal, post-surgery.

Some embodiments of the disclosed neck garment may facilitate calming effect and promote better sleep.

Some embodiments of the disclosed neck garment may enable the mammal to wear the neck/head garment for a prolonged amount of time.

Some embodiments may enable the neck garment for calming the mammal.

Some embodiments of the disclosed neck garment may facilitate cushion and thereby comfort to the mammal.

Some embodiments may disclose the neck garment to curb anxiety and fear, thereby decreasing destructive behavior of the mammal.

Some embodiments may disclose the neck garment to be comfortable in a manner such that the mammal may wear the neck garment for the lifetime.

Some embodiments may disclose the neck garment to be retrofitted with a cone like structure.

Although the neck garment for a mammal has been described in language specific to structural features and/or methods, it is to be understood that the appended claims are not necessarily limited to the specific features or methods described.

1. A neck garment for a mammal comprising:
a neck portion made by crocheting a back loop stitch, wherein the neck portion surrounds neck of a mammal;
a belt comprising a plurality of strings made by crocheting a single stitch, wherein the belt is passed through the neck portion in order to control movement of the neck portion; and
a head portion made by crocheting at least one of the single stitch, a single crochet stitch, a double crochet stitch, a double knit crochet stitch, wherein the head portion comprises a first end and a second end, and wherein the first end interconnects the neck portion by using at least one of the single stitch, the single crochet stitch, the double crochet stitch, and the double knit crochet stitch, and wherein the second end outwardly extends till head of the mammal in a manner such that the second end surrounds face of the mammal.

2. A neck portion for surrounding a neck of a mammal, wherein that the neck portion is made by crocheting at least one of a back single loop stitch and a back loop double stich.

3. The neck garment of claim 1, wherein the second end further extends beyond the head in order to restrict the mammal from licking or biting any other body part of the mammal.

4. The neck garment of claim 1, wherein the back loop stitch is at least one of a back loop single stitch and a back loop double stitch.

5. The neck garment of claim 1, wherein the neck portion is having width ranging between 1.5 inch to 4 inch.

6. The neck garment of claim 1, wherein the neck portion is having circumference ranging between 8 inch to 22 inch.

7. The neck garment of claim 1, wherein the head portion is having length ranging between 3.75 inch to 10 inch.

8. The neck garment of claim 3, wherein the head portion is having length ranging between 4.25 inch to 14 inch.

9. The neck garment of claim 1, wherein the head portion is designed in a manner such that the head portion is having at least one of a conical shape, a circular shape and a cylindrical shape.
